(19) United States
(12) Patent Application Publication
(10) Pub. No.: US 2017/0235713 A1
(43) Pub. Date: Aug. 17, 2017

(54) SYSTEM AND METHOD FOR SELF-LEARNING REAL-TIME VALIDATION OF DATA

(71) Applicant: NetSuite Inc., San Mateo, CA (US)

(72) Inventors: Bjorn MARTENSSON, Brno (CZ); Robert GUNZINÁM, Torokbalint (HU)

(21) Appl. No.: 14/513,962

(22) Filed: Oct. 14, 2014

Related U.S. Application Data
(60) Provisional application No. 61/983,029, filed on Apr. 23, 2014.

(51) Int. Cl. G06F 17/24; G06F 3/0481

(52) U.S. Cl. CPC G06F 17/243; G06F 3/0481

(57) ABSTRACT

Systems, apparatuses, and methods for verifying or validating the use of a combination of data entry fields or regions that are part of a form, template, webpage, or other display capable of receiving data entered by a user. The invention determines which of the fields or regions contain data that the user has entered. This represents a specific “combination” of data entry fields in which a user has entered data. The invention then determines whether the user's combination of data entry fields is a valid or acceptable one. If the user's combination of data entry fields represents a combination that was previously determined to be valid, then the entered data is accepted as valid and stored or processed as appropriate. However, if the user's combination of data entry fields does not represent a combination that was previously determined to be valid, then the invention determines if a default rule or condition applies that may be used to determine if the user's combination should be accepted as valid or not accepted as valid. If a default rule is applicable, then that rule or condition is applied, followed by the corresponding storage or non-storage of the combination. If a default rule is not applicable, then the system executes a verification/validation process on the user's combination.

### CROSS REFERENCE TO RELATED APPLICATION

This application claims the benefit of U.S. Provisional Application No. 61/983,029, entitled “System and Method for Self-Learning Real-Time Validation of Data,” filed Apr. 23, 2014, which is incorporated herein by reference in its entirety (including Appendix) for all purposes.

### BACKGROUND

A user of a data processing platform, system, or application often desires to enter data into one or more “fields” or regions of a form or template. This is typically accomplished by presenting a user interface to the user, where the user interface has spaces, fields, or regions in which data may be entered. A form or other data entry mechanism may have multiple fields or regions in which data may be entered, and in some cases only certain combinations of those fields or regions may be valid ones (i.e., not every possible combination of data fields or regions is a set of data that can be processed by the system or that can co-exist because of certain rules, limitations, conditions, valid ranges or values, etc.).

The large number of possible combinations of fields or regions in which data can be entered by a user can present a significant challenge if a system attempts to determine that a particular combination is valid, where such a determination may be desirable in order to prevent unproductive data processing cycles or error processing that can delay orders and frustrate users. However, if the number of possible combinations of data entry fields or regions is relatively large, then determining which combinations, if any, are valid or invalid may itself require significant data processing cycles.

Conventional approaches to determining whether data entered into a certain combination of data entry fields or regions is a valid combination for a particular application or use case typically rely on a set of defined rules or conditions that are evaluated after data is entered and/or an error checking procedure that is used with instructions sent to a user that identify the problem and suggest a correction (such as highlighting incorrect or incompatible entries, etc.). However, as the number of possible data entry fields becomes larger, the number of possible combinations of fields that may be used becomes so large that conventional approaches are inefficient and in some cases computationally intractable. Embodiments of the invention are directed toward solving these and other problems individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key, required, or essential features of the claimed subject matter, nor is it intended to be used in isolation to determine the scope of the claimed subject matter. The subject matter should be understood by reference to appropriate portions of the entire specification of this patent, to any or all drawings, and to each claim.

Embodiments of the invention are directed to systems, apparatuses, and methods for verifying or validating the use of a combination of data entry fields or regions that are part of a form, template, webpage, or other display capable of receiving data entered by a user. In one embodiment, the inventive system, apparatus, device, method, or process presents a user with a set of data entry fields or regions. These fields or regions may be of any suitable form, including but not limited to a form, template, web page, display, or other form of document/data entry form. The invention then determines which of the fields or regions contain data that the user has entered. This represents a specific “combination” of data entry fields in which a user has entered data. The invention then determines whether the user's combination of data entry fields is a valid or acceptable one. If the user's combination of data entry fields represents a combination that was previously determined to be valid, then the entered data is accepted as valid and stored or processed as appropriate. However, if the user's combination of data entry fields does not represent a combination that was previously determined to be valid, then the invention determines if a default rule or condition applies that may be used to determine if the user's combination should be accepted as valid or not accepted as valid.

If a default rule is applicable, then that rule or condition is applied, followed by the corresponding storage or non-storage of the combination (i.e., if the rule or condition results in determining that the combination is valid, then the combination or a representation of the combination may be stored for later reference). If a default rule is not applicable, then the system executes a verification/validation process on the user's combination. The verification/validation process may include any suitable evaluation or data processing method, functions, or operations. If the combination passes the verification/validation process, then the newly verified/validated combination of data entry fields or regions (or a representation of it) may be stored in an appropriate record, file, database, data storage element, etc. If the combination does not pass the verification/validation process, then the combination of data entry fields or regions is rejected and is not stored.

In one embodiment, the invention is directed to a method for validating a set of inputs provided by a user, where the method includes:

receiving the set of inputs from the user;

determining a combination of populated data entry fields or regions into which the user has provided the set of inputs;

determining if the combination of populated data entry fields or regions represents a combination that was previously determined to be valid or invalid;

if the combination of populated data entry fields or regions represents a combination that was previously determined to be valid, then accepting the combination for further processing;

if the combination of populated data entry fields or regions represents a combination that was previously determined to be invalid, then rejecting the combination for further processing;

if the combination of populated data entry fields or regions represents a combination that was not previously determined to be valid or invalid, then determining if a default rule exists that may be applied to determine if the combination represents a valid or invalid combination;

if a default rule exists, then applying the default rule;

if a default rule does not exist, then performing a verification or validation process on the combination of populated data entry fields or regions;

if the verification or validation process indicates that the combination is valid, then storing information indicating the validity of the combination.

In another embodiment, the invention is directed to an apparatus for validating a set of inputs provided by a user, where the apparatus includes:

a processor programmed to execute a set of instructions;

a data storage element in which the set of instructions are stored, wherein when executed by the processor the set of instructions cause the apparatus to
receive the set of inputs from the user;
determine a combination of populated data entry fields or regions into which the user has provided the set of inputs;
determine if the combination of populated data entry fields or regions represents a combination that was previously determined to be valid or invalid;
if the combination of populated data entry fields or regions represents a combination that was previously determined to be valid, then accept the combination for further processing;
if the combination of populated data entry fields or regions represents a combination that was previously determined to be invalid, then reject the combination for further processing;
if the combination of populated data entry fields or regions represents a combination that was not previously determined to be valid or invalid, then determine if a default rule exists that may be applied to determine if the combination represents a valid or invalid combination;
if a default rule exists, then apply the default rule;
if a default rule does not exist, then perform a verification or validation process on the combination of populated data entry fields or regions; and
if the verification or validation process indicates that the combination is valid, then store information indicating the validity of the combination.

In yet another embodiment, the invention is directed to a multi-tenant data processing system, where the system includes:

one or more business related data processing applications installed in the system and accessible by a plurality of tenants of the multi-tenant data processing system;

a data storage element accessible by a plurality of tenants of the multi-tenant data processing system;

a processor programmed with a set of instructions, wherein when executed by the processor the instructions cause the system to validate a set of inputs provided by a user by
receiving the set of inputs from the user;
determining a combination of populated data entry fields or regions into which the user has provided the set of inputs;
determining if the combination of populated data entry fields or regions represents a combination that was previously determined to be valid or invalid;
if the combination of populated data entry fields or regions represents a combination that was previously determined to be valid, then accepting the combination for further processing;
if the combination of populated data entry fields or regions represents a combination that was previously determined to be invalid, then rejecting the combination for further processing;
if the combination of populated data entry fields or regions represents a combination that was not previously determined to be valid or invalid, then determining if a default rule exists that may be applied to determine if the combination represents a valid or invalid combination;
if a default rule exists, then applying the default rule;
if a default rule does not exist, then performing a verification or validation process on the combination of populated data entry fields or regions; and
if the verification or validation process indicates that the combination is valid, then storing information indicating the validity of the combination.

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIG. 1 is a diagram illustrating elements or components that may be present in a computer device or system configured to implement a method, process, function, or operation in accordance with an embodiment of the invention;

FIG. 2 is a diagram illustrating elements or components of an example operating environment in which an embodiment of the invention may be implemented;

FIG. 3 is a diagram illustrating additional details of the elements or components of the multi-tenant distributed computing service platform of FIG. 2, in which an embodiment of the invention may be implemented;

FIG. 4(a) is a flow chart or flow diagram illustrating a process, method, operation, or function for validating a combination of data entry fields or regions into which data has or will be entered that may be used when implementing an embodiment of the invention; and

FIG. 4(b) is a flow chart or flow diagram illustrating another process, method, operation, or function for validating a combination of data entry fields or regions into which data has or will be entered that may be used when implementing an embodiment of the invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

Among other things, the present invention may be embodied in whole or in part as a system, as one or more methods, or as one or more devices. Embodiments of the invention may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc.) that is part of a client device, server, network element, or other form of computing or data processing device/platform and that is programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

Embodiments of the present invention are directed to systems, apparatuses, and methods for verifying or validating the use of a combination of data entry fields or regions that are part of a form, template, webpage, or other display capable of receiving data entered by a user. In one embodiment, the inventive system, apparatus, method, or process presents a user with a set of data entry fields or regions. These fields or regions may be of any suitable type, including but not limited to a form, template, web page, display, or other type of document/data entry element. The system then receives the user's inputs which typically are data (alphanumeric, etc.) and are entered into a specific combination of the available fields or regions. The system then determines which of the fields or regions contain data that the user has entered. This represents a specific “combination” of data entry fields in which a user has entered data (as indicated by any suitable set of field identifiers, e.g., fields 1, 3, 4, 5, 8, or fields a, c, d, e, h, etc.).

The inventive system then determines whether the user's combination of data entry fields is a valid or acceptable one, where valid or acceptable refers to a combination that is one or more of complete, process-able, not inconsistent, etc. The system first determines whether the user's combination of data entry fields is one that was previously determined to be valid or acceptable. This may involve comparing the user's combination to a record of previously validated combinations, such as might be stored in a database, file, record, table, list, or other form of data storage. If the user's combination of data entry fields does represent a combination that was previously determined to be valid, then the entered data is accepted as valid and stored or processed as appropriate. However, if the user's combination of data entry fields does not represent a combination that was previously determined to be valid, then the system determines if a default rule or condition applies that may be used to determine if the user's combination should be accepted as valid or not. The default rule (if one exists) may specify a condition such as (a) combination valid if fields a and c contain X, or do not contain Y, (b) combination valid if no field contains Z, (c) combination not valid if any field contains W, etc.

If a default rule is applicable, then that rule or condition is applied/executed, followed by the corresponding storage (if determined to be valid or acceptable) or non-storage (if not found to be valid or acceptable) of the combination. If a default rule is not applicable, then the system executes a verification/validation process on the user's combination. The verification/validation process may include any suitable evaluation or data processing method, functions, or operations. This may include evaluating the impact of the particular combination with regards to potential errors or system performance issues, etc. If the combination passes the verification/validation process, then the newly verified/validated combination of data entry fields or regions may be stored in an appropriate record, file, table, etc. If the combination does not pass the verification/validation process, then the combination of data entry fields or regions is rejected.

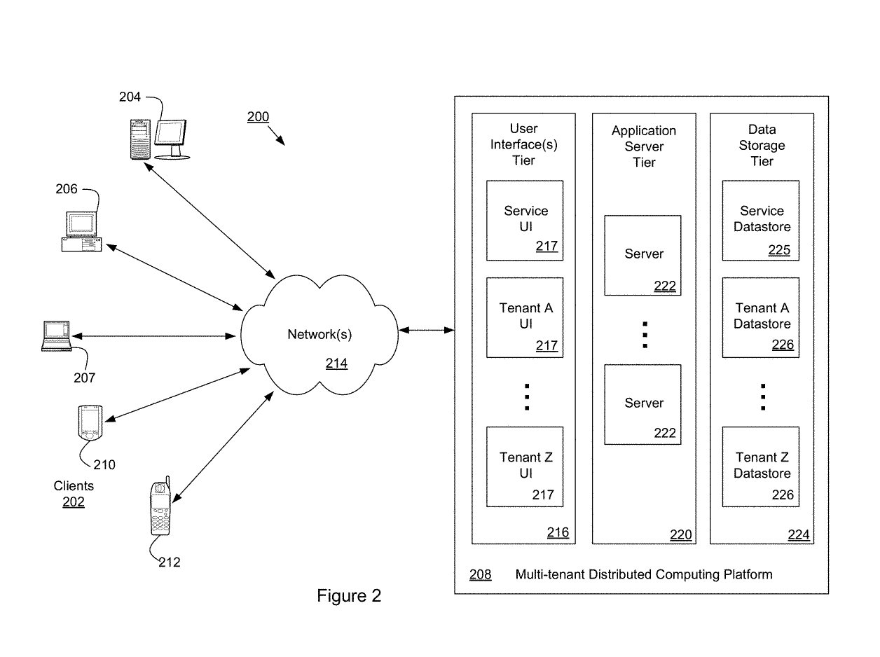

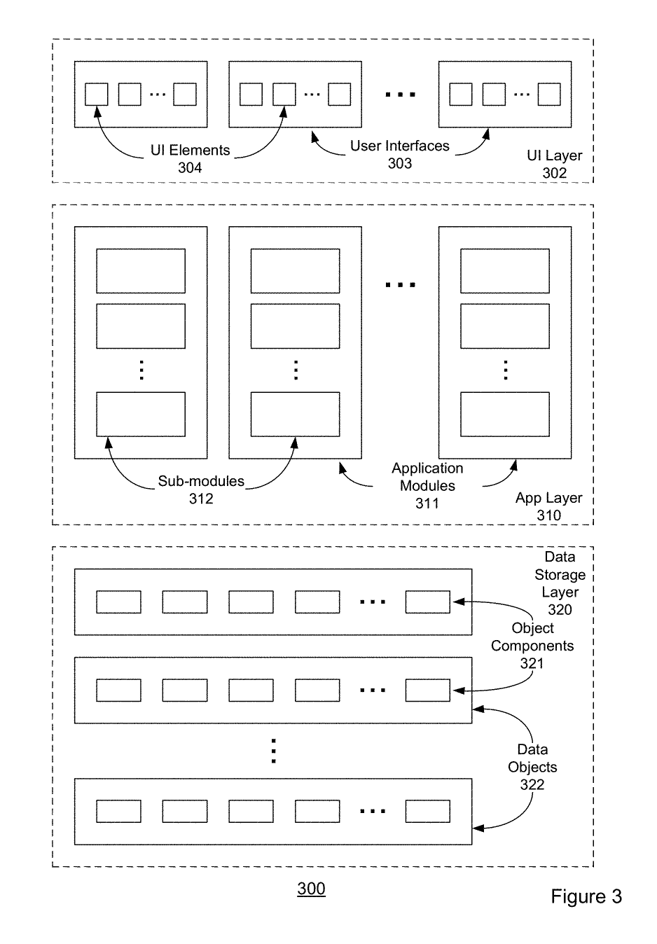

In some embodiments, the invention may be implemented in the context of a multi-tenant, “cloud” based environment (such as a multi-tenant business data processing platform), typically used to develop and provide web services for end users. This exemplary implementation environment will be described with reference to FIGS. 2 and 3. Note that embodiments of the invention may also be implemented in the context of other computing, data processing, or operational environments or systems, such as for an individual business data processing system, a private network used with a plurality of client terminals, a remote or on-site data processing system, another form of client-server architecture, in conjunction with forms or data presented via a website, etc.

Modern computer networks incorporate layers of virtualization so that physically remote computers and computer components can be allocated to a particular task and then reallocated when the task is done. Users sometimes speak in terms of computing “clouds” because of the way groups of computers and computing components can be formed and split responsive to user demand, and because users often never see the computing hardware that ultimately provides the computing services. More recently, different types of computing clouds and cloud services have begun emerging.

For the purposes of this description, cloud services may be divided broadly into “low level” services and “high level” services. Low level cloud services (sometimes called “raw” or “commodity” services) typically provide little more than virtual versions of a newly purchased physical computer system: virtual disk storage space, virtual processing power, an operating system, and perhaps a database such as an RDBMS. In contrast, high or higher level cloud services typically focus on one or more well-defined end user applications, such as business oriented applications. Some high level cloud services provide an ability to customize and/or extend the functionality of one or more of the end user applications they provide; however, high level cloud services typically do not provide direct access to low level computing functions.

The ability of business users to access crucial business information has been greatly enhanced by the proliferation of IP-based networking together with advances in object oriented Web-based programming and browser technology. Using these advances, systems have been developed that permit web-based access to business information systems, thereby allowing a user with a browser and an Internet or intranet connection to view, enter, or modify business information. For example, substantial efforts have been directed to Enterprise Resource Planning (ERP) systems that integrate the capabilities of several historically separate business computing systems into a common system, with a view toward streamlining business processes and increasing efficiencies on a business-wide level. By way of example, the capabilities or modules of an ERP system may include (but are not required to include, nor limited to only including): accounting, order processing, time and billing, inventory management, employee management/payroll, human resources management, and employee calendaring and collaboration, as well as reporting and analysis capabilities relating to these functions.

In a related development, substantial efforts have also been directed to integrated Customer Relationship Management (CRM) systems, with a view toward obtaining a better understanding of customers, enhancing service to existing customers, and acquiring new and profitable customers. By way of example, the capabilities or modules of a CRM system can include (but are not required to include, nor limited to only including): sales force automation (SFA), marketing automation, contact list management, call center support, and web-based customer support, as well as reporting and analysis capabilities relating to these functions. With differing levels of overlap with ERP/CRM initiatives and with each other, efforts have also been directed toward development of increasingly integrated partner and vendor management systems, web store/eCommerce systems, product lifecycle management (PLM) systems, and supply chain management (SCM) systems.

FIG. 2 is a diagram illustrating elements or components of an example operating environment 200 in which an embodiment of the invention may be implemented. As shown, a variety of clients 202 incorporating and/or incorporated into a variety of computing devices may communicate with a distributed computing service/platform 208 through one or more networks 214. For example, a client may incorporate and/or be incorporated into a client application (e.g., software) implemented at least in part by one or more of the computing devices. Examples of suitable computing devices include personal computers, server computers 204, desktop computers 206, laptop computers 207, notebook computers, tablet computers or personal digital assistants (PDAs) 210, smart phones 212, cell phones, and consumer electronic devices incorporating one or more computing device components, such as one or more electronic processors, microprocessors, central processing units (CPU), or controllers. Examples of suitable networks 214 include networks utilizing wired and/or wireless communication technologies and networks operating in accordance with any suitable networking and/or communication protocol (e.g., the Internet).

The distributed computing service/platform (which may also be referred to as a multi-tenant business data processing platform) 208 may include multiple processing tiers, including a user interface tier 216, an application server tier 220, and a data storage tier 224. The user interface tier 216 may maintain multiple user interfaces 217, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs). The default user interface may include components enabling a tenant to administer the tenant's participation in the functions and capabilities provided by the service platform, such as accessing data, causing the execution of specific data processing operations, etc. Each processing tier shown in the figure may be implemented with a set of computers and/or computer components including computer servers and processors, and may perform various functions, methods, processes, or operations as determined by the execution of a software application or set of instructions. The data storage tier 224 may include one or more data stores, which may include a Service Data store 225 and one or more Tenant Data stores 226.

Each tenant data store 226 may contain tenant-specific data that is used as part of providing a range of tenant-specific business services or functions, including but not limited to ERP, CRM, eCommerce, Human Resources management, payroll, etc. Data stores may be implemented with any suitable data storage technology, including structured query language (SQL) based relational database management systems (RDBMS).

In accordance with one embodiment of the invention, distributed computing service/platform 208 may be multi-tenant and service platform 208 may be operated by an entity in order to provide multiple tenants with a set of business related applications, data storage, and functionality. These applications and functionality may include ones that a business uses to manage various aspects of its operations. For example, the applications and functionality may include providing web-based access to business information systems, thereby allowing a user with a browser and an Internet or intranet connection to view, enter, process, or modify certain types of business information.

As noted, such business information systems may include an Enterprise Resource Planning (ERP) system that integrates the capabilities of several historically separate business computing systems into a common system, with the intention of streamlining business processes and increasing efficiencies on a business-wide level. By way of example, the capabilities or modules of an ERP system may include: accounting, order processing, time and billing, inventory management, employee management/payroll, and employee calendaring and collaboration, as well as reporting and analysis capabilities relating to these functions. Another business information system that may be provided as part of an integrated service platform is an integrated Customer Relationship Management (CRM) system, which is designed to assist in obtaining a better understanding of customers, enhance service to existing customers, and assist in acquiring new and profitable customers. By way of example, the capabilities or modules of a CRM system may include: sales force automation (SFA), marketing automation, contact list management, call center support, and web-based customer support, as well as reporting and analysis capabilities relating to these functions. In addition to ERP and CRM functions, a business information system/platform (such as element 208 of FIG. 2) may also include one or more of an integrated partner and vendor management system, eCommerce system (e.g., a virtual storefront application or platform for use by customers of the tenant), product lifecycle management (PLM) system, Human Resources management system (which may include medical/dental insurance administration, payroll, etc.), or supply chain management (SCM) system.

Note that both functional advantages and strategic advantages may be gained through the use of an integrated business system comprising ERP, CRM, and other business capabilities, as for example where the integrated business system is integrated with a merchant's eCommerce platform and/or “web-store.” For example, a customer searching for a particular product can be directed to a merchant's website and presented with a wide array of product and/or services from the comfort of their home computer, or even from their mobile phone. When a customer initiates an online sales transaction via a browser-based interface, the integrated business system can process the order, update accounts receivable, update inventory databases and other ERP-based systems, and can also automatically update strategic customer information databases and other CRM-based systems. These modules and other applications and functionalities may advantageously be integrated and executed by a single code base accessing one or more integrated databases as necessary, forming an integrated business management system or platform.

The integrated business system shown in FIG. 2 may be hosted on a distributed computing system made up of at least one, but typically multiple, “servers.” A server is a physical computer dedicated to run one or more software services intended to serve the needs of the users of other computers in data communication with the server, for instance via a public network such as the Internet or a private “intranet” network. The server, and the services it provides, may be referred to as the “host” and the remote computers and the software applications running on the remote computers may be referred to as the “clients.” Depending on the computing service that a server offers it could be referred to as a database server, file server, mail server, print server, web server, etc. A web server is most often a combination of hardware and the associated software that helps deliver content (typically by hosting a website) to client web browsers that access the web server via the Internet.

Rather than build and maintain such an integrated business system themselves, a business may utilize systems provided by a third party. Such a third party may implement an integrated business system/platform as described above in the context of a multi-tenant platform, wherein individual instantiations of a single comprehensive integrated business system are provided to a variety of tenants. One advantage to such multi-tenant platforms is the ability for each tenant to customize their instantiation of the integrated business system to that tenant's specific business needs. Each tenant may be a business or entity that uses the multi-tenant platform to provide business data and functionality to multiple users, such as employees and customers. Some of those multiple users may have distinct roles or responsibilities within the business or entity, or be interested in entering and submitting specific types of data to the system. As a result, users may have a need for or preference to utilize different data entry forms, documents, or webpages and different data entry elements of those forms, etc. Embodiments of the invention provide a method for enabling a more efficient data entry process for users and a more cost-effective use of a platform's computing resources by determining whether a combination of data entry fields or elements used by a user is a known valid combination, and if not, determining if the combination should be accepted or rejected.

FIG. 3 is a diagram illustrating additional details of the elements or components of the multi-tenant distributed computing service platform of FIG. 2, in which an embodiment of the invention may be implemented or with which an embodiment of the invention may be used. In general, an embodiment of the invention may be used in conjunction with (and typically is implemented as) a set of software instructions that are designed to be executed by a suitably programmed processing element (such as a CPU, microprocessor, processor, controller, computing device, etc.). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 3 is a diagram illustrating additional details of the elements or components 300 of the multi-tenant distributed computing service platform of FIG. 2, in which an embodiment of the invention may be implemented. The example architecture includes a user interface layer or tier 302 having one or more user interfaces 303. Examples of such user interfaces include graphical user interfaces and application programming interfaces (APIs). Each user interface may include one or more interface elements 304. For example, users may interact with interface elements in order to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks and dialog boxes. Application programming interfaces may be local or remote, and may include interface elements such as parameterized procedure calls, programmatic objects and messaging protocols. As described herein, embodiments of the invention provide a method for determining if a set of data entry fields or interface elements used by a user represent a known valid combination, and if not, determining if they represent a set that is acceptable or valid for processing by the business data processing system or other platform.

The application layer 310 may include one or more application modules 311, each having one or more sub-modules 312. Each application module 311 or sub-module 312 may correspond to a particular function, method, process, or operation that is implemented by the module or sub-module (such as an ERP, CRM or eCommerce function). Such function, method, process, or operation may include those used to implement one or more aspects of the inventive system and methods, such as for:
Generating a user interface display that includes a plurality of data entry regions/fields (such as a form, webpage, document, table, etc.);
Receiving a set of user inputs, such as alphanumeric data or a selection indicator, into all or a subset of the plurality of data entry regions/fields;
Determining which of the plurality of regions/fields contain user entered data/indicator(s);
Determining if the combination or set of regions/fields into which data/indicator(s) have been entered is one which has previously been determined to be valid or acceptable to the data processing system;
If the set of regions/fields into which data/indicator(s) have been entered is not one which has previously been determined to be valid or acceptable, then determining if a default rule regarding the validity/acceptability of the set of data/indicator(s) is applicable; and
If the set of regions/fields into which data/indicator(s) have been entered is not one which has previously been determined to be valid/acceptable and if a default rule that can be used to determine the validity/acceptability of the set is not applicable, then executing a validation/verification process on the set (where the validation/verification process may include one or more of the development and application of a machine learning model, application of a rule-based decision process, application of one or more human inputs or evaluations, etc.).

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 222 of FIG. 2) may include each application module. Alternatively, different application servers may include different sets of application modules. Such sets may be disjoint or overlapping.

The data storage layer 320 may include one or more data objects 322 each having one or more data object components 321, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 2-3 are not intended to be limiting examples. Alternatively, or in addition, computing or data processing environments in which an embodiment of the invention may be implemented include any suitable system that permits users to access and provide data to (or a selection of an option for) a form, template, document, table, webpage, or other element having a plurality of data entry fields or regions. Further example environments in which an embodiment of the invention may be implemented include devices (including mobile devices), software applications, systems, apparatuses, networks, displays, or other components that may be used by multiple users for data entry, data processing, application execution, data review, etc. Although further examples below may reference the example computing environment depicted in FIGS. 2-3, it will be apparent to one of skill in the art that the examples may be adapted for alternate computing devices, systems, apparatuses, processes, and environments.

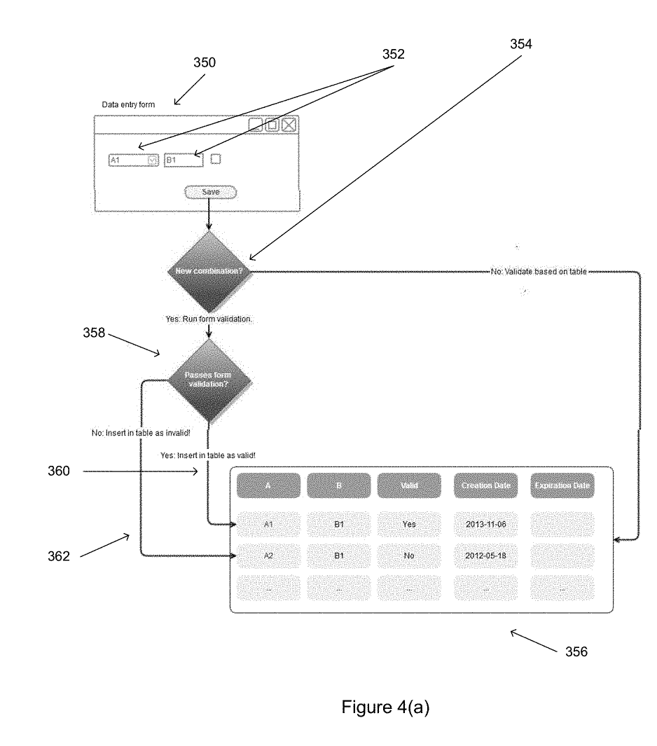

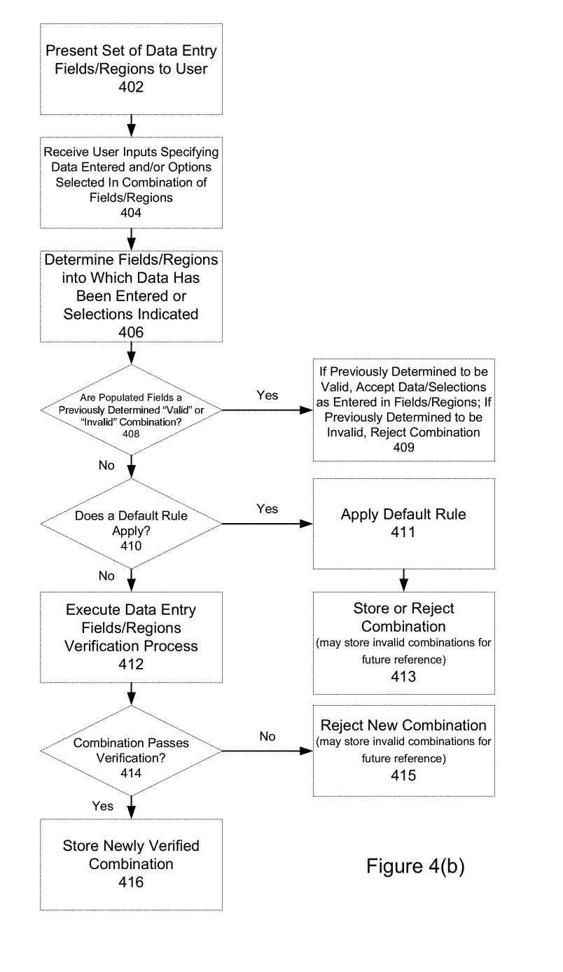

FIG. 4(a) is a flow chart or flow diagram illustrating a process, method, operation, or function for validating a combination of data entry fields or regions into which data has or will be entered that may be used when implementing an embodiment of the invention. As shown in the figure, a form, template, web page, display, or other form of document/data entry form 350 is presented to a user. Data entry form 350 includes a plurality (i.e., more than one) of fields or regions 352 into which a user may enter data or indicate a selection (such as a check box, etc.). In one embodiment, after the user enters the data they choose to enter and/or selects the desired options, the inventive process determines whether the combination of data entry fields or regions into which data has been entered and options selected is a new combination (i.e., one not previously specified or validated, as illustrated by step 354). If the combination is not new (as suggested by the logic path labeled “No: Validate based on table”), then the combination is checked against a list or table 356 of validated/invalidated combinations. In one embodiment, the list or table contains information sufficient to determine if a specified combination is valid or invalid with regards to its use as inputs to the computing or data processing system. If the combination is new (as suggested by the logic path labeled “Yes: Run form validation”), then the combination is processed to determine if it is valid (which may be determined by application of one or more rules, conditions, tests, etc.), as illustrated by step 358. If the combination passes the validation test, then it is recorded as a valid combination in the list or table 356 of validated/invalidated combinations (as illustrated by step 360). If the combination fails the validation test, then it is recorded as an invalid combination in the list or table 356 of validated/invalidated combinations (as illustrated by step 362).

FIG. 4(b) is a flow chart or flow diagram illustrating another process, method, operation, or function for validating a combination of data entry fields or regions into which data has or will be entered that may be used when implementing an embodiment of the invention. As shown in the figure, a system or process presents a user with a set of data entry fields or regions (step or stage 402). These fields or regions may be of any suitable form, including but not limited to a form, template, web page, display, or other form of document/data entry form. The user may enter data and/or select options using a suitable user interface display, with the display provided on a terminal, mobile device, laptop computer, tablet computer, desktop computer, or other suitable device or apparatus. In one embodiment, the user may enter the data using one of the user interfaces 217 illustrated in FIG. 2. Note that such a user interface may be one that has been configured in accordance with the needs of a specific tenant of a multi-tenant platform, and thus may contain specific user interface elements (such as those illustrated by element 304 of FIG. 3).

The user enters the data and/or indicates selections and the data/selections (or a representation) are provided to a computing or data processing device (such as a data processing platform, a server, a computer, etc.), typically by means of a suitable data communications network (for example, Network 214 of FIG. 2). In one embodiment, the computing or data processing device may be the multi-tenant distributed computing platform 208 of FIG. 2. The data processing system, platform, or device receives the user's inputs which typically are data (alphanumeric, etc.) and/or selected options and are entered into a specific combination of the fields or regions (step or stage 404; an example would be of data entered into regions 1, 2, and 7 of a template that had 10 possible data entry regions). The system then determines which of the fields or regions contain data/selections that the user has entered (step or stage 406). This represents a specific “combination” of populated data entry fields in which a user has entered data or indicated a selection.

The inventive system then determines whether the user's combination of populated data entry fields is a valid or acceptable one. In one embodiment, this involves the process illustrated in steps 408-416. The system first determines whether the user's combination of populated data entry fields is one that was previously determined to be valid or invalid (step or stage 408). This may involve comparing the user's combination to a record of previously validated/invalidated combinations, such as might be stored in a database, file, record, table, list, or other form of data storage. If the user's combination of populated data entry fields does represent a combination that was previously determined to be valid or invalid (as illustrated by the “Yes” branch of step 408), then if the user's combination of data entry fields was previously determined to valid, the entered data is accepted and stored or processed as appropriate (step or stage 409). However, if the user's combination of data entry fields represents a combination that was previously determined to be invalid, then the entered data is rejected and a warning or notification to the user may be generated (step or stage 409).

If the user's combination of populated data entry fields does not represent a combination that was previously determined to be valid or invalid (as illustrated by the “No” branch of step 408), then the inventive system determines if a default rule or condition applies that may be used to determine if the user's combination should be accepted as valid or rejected as invalid (step or stage 410). Examples of possible default rules or conditions that may be applied include, but are not limited to (a) rejection of all combinations that were not previously validated, (b) acceptance of all combinations that were not previously validated, (c) acceptance or rejection of all combinations that include data entered into a specific field or region, or set of fields or regions, (d) acceptance or rejection of all combinations which do not include data entered into a specific field or region, or set of fields or regions, etc. If a default rule is applicable (as illustrated by the “Yes” branch of step 410), then that rule or condition is applied (step or stage 411), followed by the corresponding storage or non-storage of the combination (step or stage 413). Note that in one embodiment, invalid combinations (such as those that are rejected based on application of a default rule) may be stored for future reference (such as by having the system review “invalid” combinations as part of determining if a validation/verification process or other process is to be executed).

If a default rule is not applicable (as illustrated by the “No” branch of step 410), then the system executes a verification/validation process on the user's combination (step or stage 412). The verification/validation process may include any suitable evaluation or data processing method, functions, or operations. This may include evaluating the impact of the particular combination with regards to potential errors or system performance issues, later data processing problems that may arise due to errors generated by one or more processes or rules, etc. As an example, if the form or region takes an IP address as an input, then a suitable validation process might be to ping the IP address and wait for a reply, with a time-out of ten seconds. If it times out, then the IP address could be saved as invalid for the next 10 days (after which it could be tried again by users).

If the combination passes the verification/validation process (as illustrated by the “Yes” branch of step 414), then the newly verified/validated combination of data entry fields or regions may be stored in an appropriate record, file, table, list, etc. (step or stage 416). If the combination does not pass the verification/validation process (as illustrated by the “No” branch of step 414), then the combination of data entry fields or regions is rejected (step or stage 415). Note that in one embodiment, invalid combinations (such as those that are rejected based on application of the validation/verification process) may be stored for future reference (such as by having the system review “invalid” combinations as part of determining if a validation/verification process or other process is to be executed).

Note that in one embodiment, the whole or part of a validation/verification process may include executing a review/approval process that includes human inputs. For example, in some cases acceptance or rejection of a proposed combination may involve human review of the proposed combination and input of human generated comments, conditions, tests, rules, an acceptance or rejection decision, etc. In one embodiment, an authorized user could periodically (e.g., weekly) review any combinations that have been entered since the last review was conducted and verify that their validity status is correct. This approach (alone or in combination with one or more of machine learning techniques, rule-based evaluations, pattern matching, statistical analysis, etc.) may be beneficial in situations where data values and/or possible combinations are subject to great variety, to account for the impact of social mores or dynamically changing rules, etc.

Note also that although the description and claims refer to a “user” or “user inputs”, this is not intended to limit the user or provider of inputs to being a human/person. In some embodiments, the “user” may instead be a machine functioning as a source of input data. For example, the user could be a web services/programmatic interface that is used by a computer accessing a form or data input region via a network. Further, the use of the description “alphanumeric data” is not meant to limit use of an embodiment of the invention to any particular language or number system. For example, an embodiment of the invention may be used with an interface that accepts user inputs in one or more languages (e.g., English, Chinese, etc.) and/or in one or more numerical or symbolic systems (binary, decimal, Roman numerals, logical, etc.).

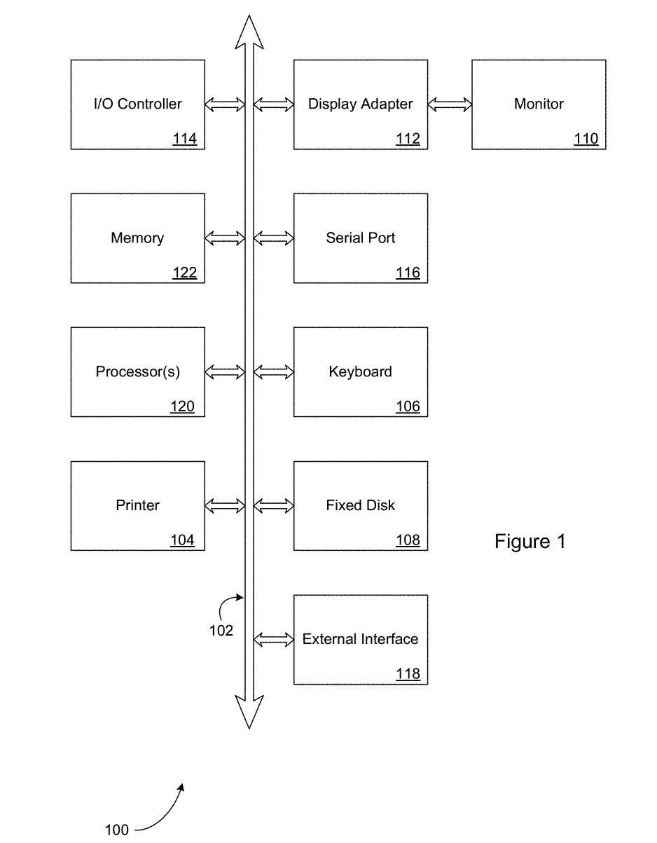

In accordance with one embodiment of the invention, the system, apparatus, methods, processes, functions, and/or operations for enabling efficient configuration and presentation of a user interface to a user based on the user's previous behavior may be wholly or partially implemented in the form of a set of instructions executed by one or more programmed computer processors such as a central processing unit (CPU) or microprocessor. Such processors may be incorporated in an apparatus, server, network element, client or other computing or data processing device operated by, or in communication with, other components of the system. As an example, FIG. 1 is a diagram illustrating elements or components that may be present in a computer device or system 100 configured to implement a method, process, function, or operation in accordance with an embodiment of the invention. The subsystems shown in FIG. 1 are interconnected via a system bus 102. Additional subsystems include a printer 104, a keyboard 106, a fixed disk 108, and a monitor 110, which is coupled to a display adapter 112. Peripherals and input/output (I/O) devices, which couple to an I/O controller 114, can be connected to the computer system by any number of means known in the art, such as a serial port 116. For example, the serial port 116 or an external interface 118 can be utilized to connect the computer device 100 to further devices and/or systems not shown in FIG. 1 including a wide area network such as the Internet, a mouse input device, and/or a scanner. The interconnection via the system bus 102 allows one or more processors 120 to communicate with each subsystem and to control the execution of instructions that may be stored in a system memory 122 and/or the fixed disk 108, as well as the exchange of information between subsystems. The system memory 122 and/or the fixed disk 108 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, Javascript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

1. A method, comprising:
receiving a set of inputs from a user;
determining one or more populated data entry fields or regions into which the user has provided the set of inputs, the one or more populated data entry fields or regions forming a combination of populated data entry fields or regions;
determining if the combination of populated data entry fields or regions represents a combination of data entry fields or regions that was previously determined to be valid or invalid, where a valid combination is a set of data entry fields or regions that is acceptable;
if the combination of populated data entry fields or regions represents a combination that was previously determined to be valid, then accepting the combination for further processing;
if the combination of populated data entry fields or regions represents a combination that was previously determined to be invalid, then rejecting the combination for further processing;
if the combination of populated data entry fields or regions represents a combination that was not previously determined to be valid or invalid, then determining if a default rule exists that may be applied to determine if the combination represents a valid or invalid combination;
if a default rule exists, then applying the default rule;
if a default rule does not exist, then performing a verification or validation process on the combination of populated data entry fields or regions; and
if the verification or validation process indicates that the combination is valid, then storing information indicating the validity of the combination.

2. The method of claim 1, wherein the set of inputs are one or more of text, alphanumeric data or an indication of a user selection.

3. The method of claim 1, wherein the default rule that is applied is one that specifies one or more of
a set of fields or regions in which data must be entered in order that a combination be valid;
a set of fields or regions in which data must not be entered in order that a combination be valid;
a value or values that a field or region must have in order that a combination be valid; or
a value or values that a field or region must not have in order that a combination be valid.

4. The method of claim 1, wherein the verification or validation process performed on the combination of populated data entry fields or regions is one or more of a machine learning technique, a statistical analysis, pattern matching, an evaluation of the impact of the combination on a data processing operation, or a human decision process.

5. The method of claim 1, wherein receiving the set of inputs from the user further comprises receiving the set of inputs by presenting a display or user interface to the user.

6. The method of claim 5, wherein the display or user interface is generated by a multi-tenant data processing system or platform.

7. The method of claim 6, wherein the display or user interface is configured to contain data entry fields or regions associated with the user.

8. The method of claim 1, further comprising if the verification or validation process indicates that the combination is not valid, then storing information indicating the invalidity of the combination.

9. An apparatus, comprising:
a processor programmed to execute a set of instructions;
a data storage element in which the set of instructions are stored, wherein when executed by the processor the set of instructions cause the apparatus to
receive a set of inputs from a user;
determine one or more populated data entry fields or regions into which the user has provided the set of inputs, the one or more populated data entry fields or regions forming a combination of populated data entry fields or regions;
determine if the combination of populated data entry fields or regions represents a combination of data entry fields or regions that was previously determined to be valid or invalid, where a valid combination is a set of data entry fields or regions that is acceptable;
if the combination of populated data entry fields or regions represents a combination that was previously determined to be valid, then accept the combination for further processing;
if the combination of populated data entry fields or regions represents a combination that was previously determined to be invalid, then reject the combination for further processing;
if the combination of populated data entry fields or regions represents a combination that was not previously determined to be valid or invalid, then determine if a default rule exists that may be applied to determine if the combination represents a valid or invalid combination;
if a default rule exists, then apply the default rule;
if a default rule does not exist, then perform a verification or validation process on the combination of populated data entry fields or regions; and
if the verification or validation process indicates that the combination is valid, then store information indicating the validity of the combination.

10. The apparatus of claim 9, wherein the set of inputs are one or more of text, alphanumeric data or an indication of a user selection.

11. The apparatus of claim 9, wherein the default rule that is applied is one that specifies one or more of
a set of fields or regions in which data must be entered in order that a combination be valid;
a set of fields or regions in which data must not be entered in order that a combination be valid;
a value or values that a field or region must have in order ha a combination be valid; or
a value or values that a field or region must not have in order that a combination be valid.

12. The apparatus of claim 9, wherein the verification or validation process performed on the combination of populated data entry fields or regions is one or more of a machine learning technique, a statistical analysis, pattern matching, an evaluation of the impact of the combination on a data processing operation, or a human decision process.

13. The apparatus of claim 9, wherein receiving the set of inputs from the user further comprises receiving the set of inputs by presenting a display or user interface to the user.

14. The apparatus of claim 13, wherein the display or user interface is configured to contain data entry fields or regions associated with the user.

15. The apparatus of claim 9, wherein the set of instructions cause the apparatus to store information indicating the invalidity of the combination if the verification or validation process indicates that the combination is not valid.

16. A multi-tenant data processing system, comprising:
one or more business related data processing applications installed in the system and accessible by a plurality of tenants of the multi-tenant data processing system;
a data storage element containing data associated with the plurality of tenants of the multi-tenant data processing system;
a processor programmed with a set of instructions, wherein when executed by the processor the instructions cause the system to
receive a set of inputs from a user;
determine one or more populated data entry fields or regions into which the user has provided the set of inputs, the one or more populated data entry fields or regions forming a combination of populated data entry fields or regions;
determine if the combination of populated data entry fields or regions represents a combination of data entry fields or regions that was previously determined to be valid or invalid, where a valid combination is a set of data entry fields or regions that is acceptable;
if the combination of populated data entry fields or regions represents a combination that was previously determined to be valid, then accepting the combination for further processing;
if the combination of populated data entry fields or regions represents a combination that was previously determined to be invalid, then rejecting the combination for further processing;
if the combination of populated data entry fields or regions represents a combination that was not previously determined to be valid or invalid, then determining if a default rule exists that may be applied to determine if the combination represents a valid or invalid combination;
if a default rule exists, then applying the default rule;
if a default rule does not exist, then performing a verification or validation process on the combination of populated data entry fields or regions; and
if the verification or validation process indicates that the combination is valid, then storing information indicating the validity of the combination.

17. The system of claim 16, wherein the business related data processing applications installed in the system include one or more of an enterprise resource planning, customer relationship management or eCommerce application.

18. The system of claim 16, wherein the set of inputs are one or more of text, alphanumeric data or an indication of a user selection.

19. The system of claim 16, wherein the default rule that is applied is one that specifies one or more of
a set of fields or regions in which data must be entered in order that a combination be valid;
a set of fields or regions in which data must not be entered in order that a combination be valid;
a value or values that a field or region must have in order that a combination be valid; or
a value or values that a field or region must not have in order that a combination be valid.

20. The system of claim 16, wherein the verification or validation process performed on the combination of populated data entry fields or regions is one or more of a machine learning technique, a statistical analysis, pattern matching, an evaluation of the impact of the combination on a data processing operation, or a human decision process.

21. The system of claim 16, wherein receiving the set of inputs from the user further comprises receiving the set of inputs by presenting a display or user interface to the user.

22. The system of claim 21, wherein the display or user interface is configured to contain data entry fields or regions associated with the user or a specific tenant.

23. The system of claim 16, wherein the instructions cause the system to store information indicating the invalidity of the combination if the verification or validation process indicates that the combination is not valid.
